(19) United States
(12) Patent Application Publication
(10) Pub. No.: US 2014/0063815 A1
(43) Pub. Date: Mar. 6, 2014

(54) LED LAMP

(71) Applicant: Ching-Tien Lin, Taichung City (TW)

(72) Inventor: Ching-Tien Lin, Taichung City (TW)

(21) Appl. No.: 13/804,338

(22) Filed: Mar. 14, 2013

(30) Foreign Application Priority Data
Aug. 30, 2012 (TW) 101216691

(51) Int. Cl. F21V 13/04

(52) U.S. Cl. CPC F21V 13/04
USPC 362/309

(57) ABSTRACT

An LED lamp includes a base, a driving circuit board mounted to the base, a lighting module, a light guide member, and a reflecting member for reflecting light transmitted from the light guide member. The lighting module includes LEDs annularly disposed on and connected electrically to the driving circuit board. The light guide member has a light-receiving end corresponding in position to the LEDs. The reflecting member has an annular reflecting portion disposed in the light guide member, and a covering portion extending outwardly from a distal end of the annular reflecting portion and covering a distal end of the light guide member.

### CROSS-REFERENCE TO RELATED APPLICATION

This application claims priority of Taiwanese Patent Application No. 101216691, filed on Aug. 30, 2012.

### BACKGROUND OF THE INVENTION

1. Field of the Invention

The invention relates to a lamp, more particularly to an LED lamp.

2. Description of the Related Art

In recent years, matured light emitting diode (LED) technology has been applied to a variety of illuminating apparatuses due to advantages such as having high illuminating efficiency, long service life, fast response, and high reliability.

Referring to FIG. 1, a conventional LED lamp includes abase 11, a plurality of LEDs 12, and an opaque light cover 13 for covering the LEDs 12. By utilizing the light cover 13, the conventional LED lamp is capable of softening the glare of the light illuminated from the LEDs 12. However, due to the limited illuminating angle of the LED as a point source of light, a relatively great number of LEDs is needed for producing an even illumination distribution, and thus generating a relatively high yet undesirable amount of heat.

### SUMMARY OF THE INVENTION

Therefore, the object of the present invention is to provide an LED lamp to overcome the aforesaid drawbacks.

Accordingly, an LED lamp of the present invention includes:

a base;

a driving circuit board mounted to the base;

a lighting module including a plurality of spaced-apart light emitting diodes that are annularly disposed on and electrically connected to the driving circuit board;

a hollow light guide member having a light-receiving end that is connected to the base, that corresponds in position to the light emitting diodes, and that is disposed for receiving light emitted from the light emitting diodes, and a distal end that is opposite to the light-receiving end; and

a reflecting member for reflecting the light transmitted from the light guide member and having an annular reflecting portion disposed in the light guide member and extending from the driving circuit board, and a covering portion that extends outwardly from a distal end of the annular reflecting portion, and that covers the distal end of the light guide member.

### BRIEF DESCRIPTION OF THE DRAWINGS

Other features and advantages of the present invention will become apparent in the following detailed description of the preferred embodiment with reference to the accompanying drawings, of which:

FIG. 1 is a cutaway perspective view of a conventional LED lamp;

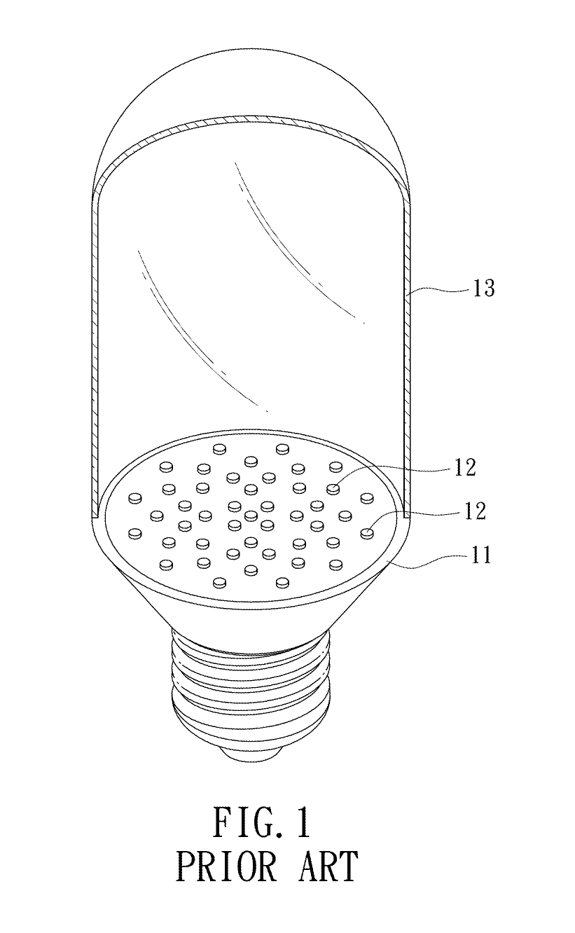

FIG. 2 is a partly sectional view of the preferred embodiment of an LED lamp according to the present invention;

FIG. 3 is a top view of LEDs and a driving circuit board of the preferred embodiment describing the arrangement of the LEDs;

FIG. 4 is an exploded sectional view of a reflecting member and a light guide member of the preferred embodiment; and

FIG. 5 is a bottom view of the light guide member of the preferred embodiment.

### DETAILED DESCRIPTION OF THE PREFERRED EMBODIMENT

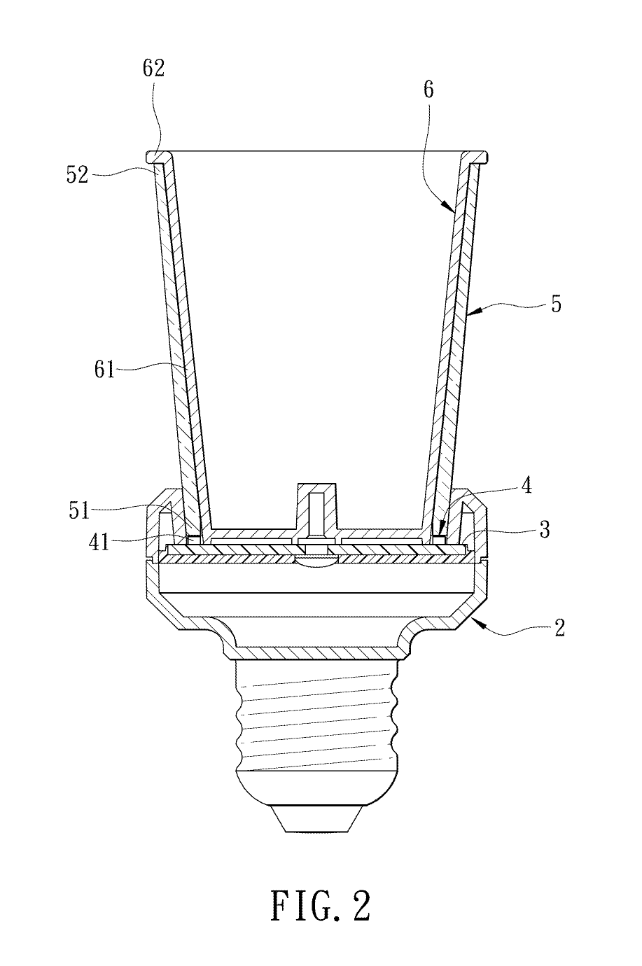

Referring to FIG. 2, the preferred embodiment of an LED lamp according to the present invention is disclosed to include a base 2, a driving circuit board 3 mounted to the base 2, a lighting module 4, a light guide member 5, and a reflecting member 6.

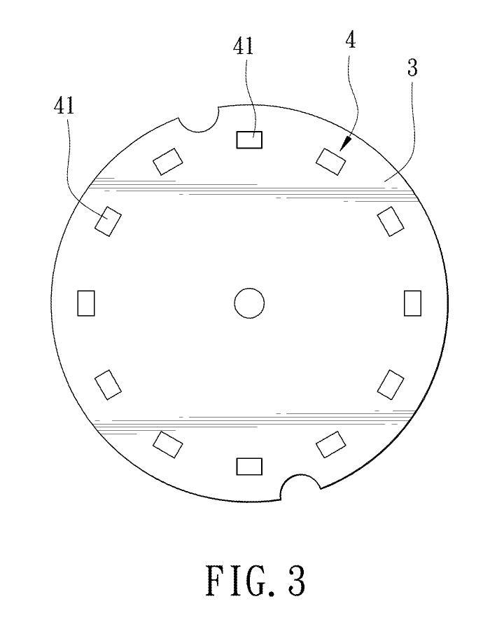

As shown in FIG. 3, the lighting module 4 has a plurality of spaced-apart LEDs 41 that are disposed annularly on and connected electrically to the driving circuit board 3.

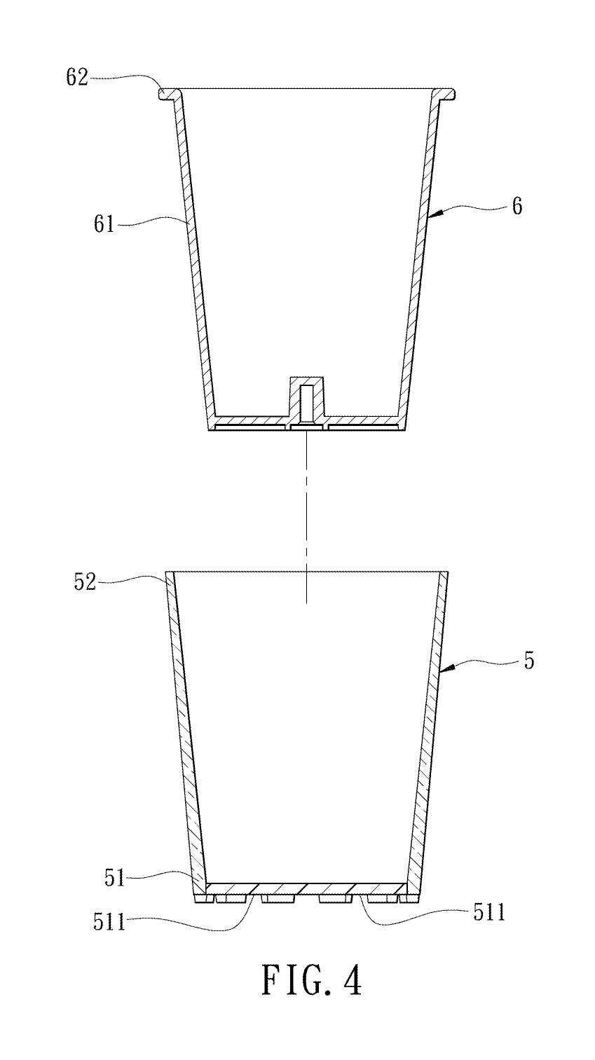

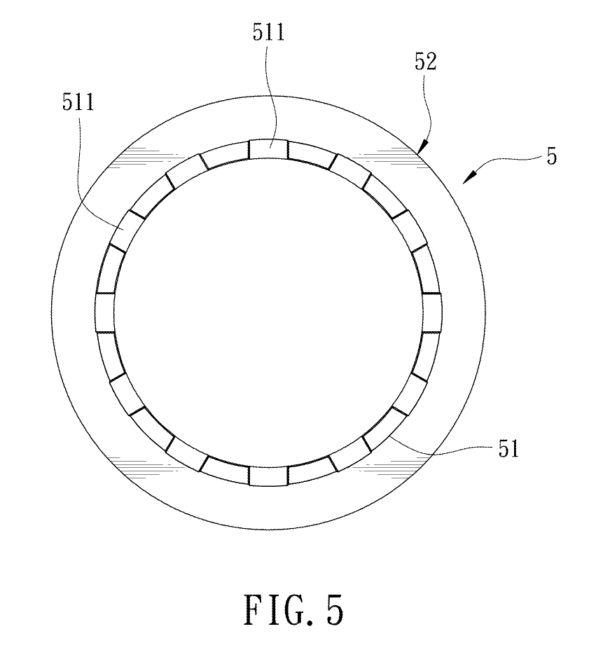

Referring back to FIG. 2, and further referring to FIGS. 4 and 5, the light guide member 5 is transparent and hollow, and has a light-receiving end 51 that is disposed on the driving circuit board 3 (i.e. the light guide member 5 is indirectly connected to the base 2), that corresponds in position to the light emitting diodes 41, and that is disposed for receiving light emitted from the light emitting diodes 41, and a distal end 52 that is opposite to the light-receiving end 51. The light-receiving end 51 of the light guide member 5 is formed with a plurality of grooves 511 for receiving respectively the LEDs 41, for improving the light receiving effect of the light guide member 5, and for positioning irrotatably the light guide member 5 on the driving circuit board 3. In this embodiment, the light guide member 5 is frustoconical and has a cross-sectional inner diameter that is decreased gradually from the distal end 52 to the light-receiving end 51. However, the shape of the light guide member 5 is not limited in other embodiments of the present invention.

The reflecting member 6 is used for reflecting the light transmitted from the light guide member 5 and has an annular reflecting portion 61 that is disposed in the light guide member 5 and that extends from the driving circuit board 3, and a covering portion 62 that extends radially and outwardly from a distal end of the annular reflecting portion 61 and that covers the distal end 52 of the light guide member 5. In this embodiment, the reflecting member 6 is white and made of a plastic material, but it is not limited in this regard in other embodiments of the present invention.

To sum up, the gradually decreasing cross-sectional inner diameter of the light guide member 5, along with the reflecting member 6, allows the transmitted light to be reflected evenly and outwardly from the reflecting member 6. Moreover, the covering portion 62 of the reflecting member 6 avoids glares due to the emission of the transmitted light from the distal end 52 of the light guide member 5, thereby resulting in even light emitting distribution of the LED lamp throughout the light guide member 5 and requiring fewer LEDs 41 compared to the conventional LED lamp.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An LED lamp comprising:
a base;
a driving circuit board mounted to said base;
a lighting module including a plurality of spaced-apart light emitting diodes that are annularly disposed on and electrically connected to said driving circuit board;
a hollow light guide member having a light-receiving end that is connected to said base, that corresponds in position to said light emitting diodes, and that is disposed for receiving light emitted from said light emitting diodes, and a distal end that is opposite to said light-receiving end; and
a reflecting member for reflecting the light transmitted from said light guide member and having an annular reflecting portion that is disposed in said light guide member and that extends from said driving circuit board, and a covering portion that extends outwardly from a distal end of said annular reflecting portion, and that covers said distal end of said light guide member.

2. The LED lamp as claimed in claim 1, wherein said light guide member has a cross-sectional inner diameter that decreases gradually from said distal end to said light-receiving end.

3. The LED lamp as claimed in claim 2, wherein said light guide member is frustoconical.

4. The LED lamp as claimed in claim 1, wherein said light-receiving end of said light guide member is formed with a plurality of grooves receiving respectively said light emitting diodes.

5. The LED lamp as claimed in claim 1, wherein said reflecting member is made of a plastic material.

6. The LED lamp as claimed in claim 1, wherein said reflecting member is white.
